(19) United States
(12) Patent Application Publication
(10) Pub. No.: US 2002/0155976 A1
(43) Pub. Date: Oct. 24, 2002

(54) Cleaning compositions

(75) Inventors: Jelles Vincent Boskamp, Vlaardingen (NL); Seeng Djiang Liem, Rhoon (NL); Rahul Dominic Vas Bhat, Vlaardingen (NL); Arie Vermaas, Vlaardingen (NL)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/002,517

(22) Filed: Nov. 1, 2001

(30) Foreign Application Priority Data
Nov. 24, 2000 (EP) 00204186.1

(51) Int. Cl. C11D 17/00

(52) U.S. Cl. 510/446; 510/447; 510/510

(57) ABSTRACT

A tablet of compacted particulate detergent composition comprising non-soap surfactant and detergency builder, and;

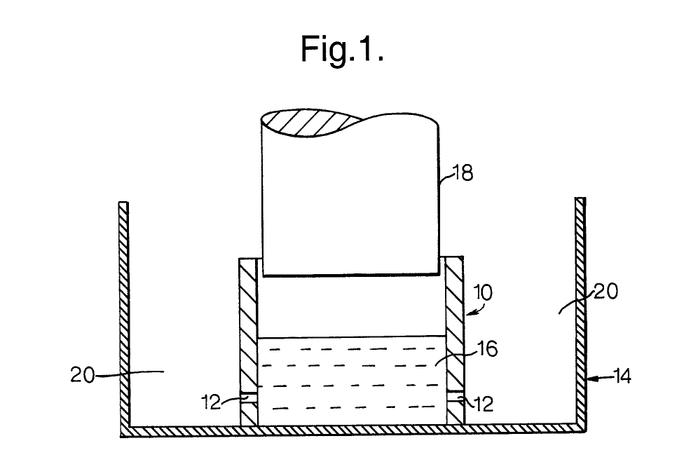

a) disintegration-promoting particles comprising water-insoluble disintegrant which can swell to at least twice its volume on contact with water, and a water-absorbent carrier which so swells to a lesser extent, and

b) water-soluble polymeric binder solid at 25° C., and either

c) comprising 2 to 30% wt of water-soluble disintegration-promoting particles comprising at least 40% of materials selected from;

compounds with water solubility at 20° C. of at least 50 grams per 100 grams of water

phase I sodium tripolyphosphate

sodium tripolyphosphate that contains water of hydration in an amount which is at least 0.5% wt of the sodium tripolyphosphate in the particles, or

d) having a diametral fracture stress of at least 14 kPa.

The tablets exhibit good disintegration properties.

This invention relates to particles intended for use as aids to disintegration in tablets of cleaning compositions. These tablets are intended to disintegrate completely when placed in water and thus to be consumed in a single use. The tablets may be suitable for use in machine dishwashing, the washing of fabrics or other cleaning tasks.

Detergent compositions in tablet form and intended for fabric washing have been described in numerous patent documents including, for example EP-A-711827, WO-98/42817 and WO-99/20730 (Unilever) and are now sold commercially. Tablets containing a water softening agent, for use as an additive in cleaning, are sold commercially and are one form of tablet disclosed in EP-A-838519 (Unilever). Tablets of composition suitable for machine dishwashing have been disclosed in EP-A-318204 and U.S. Pat. No. 5,691,293 and are sold commercially. Tablets have several advantages over powdered products: they do not require measuring and are thus easier to handle and dispense into the wash load, and they are more compact, hence facilitating more economical storage.

Tablets of a cleaning composition are generally made by compressing or compacting a composition in particulate form. Although it is desirable that tablets have adequate strength when dry, yet disperse and dissolve quickly when brought into contact with water, it can be difficult to obtain both properties together. Tablets formed using a low compaction pressure tend to crumble and disintegrate on handling and packing; while more forcefully compacted tablets may be sufficiently cohesive but then fail to disintegrate or disperse to an adequate extent in the wash. Tableting will often be carried out with enough pressure to achieve a compromise between these desirable but antagonistic properties.

However, it remains desirable to improve one or other of these properties without detriment to the other so as to improve the overall compromise between them. Thus, if the speed of disintegration can be improved without reducing the strength, the manufacturer may choose to compact the particulate composition more forcefully and thereby make stronger tablets which disintegrate at the same speed as before.

If a tablet contains organic surfactant, this functions as a binder, plasticising the tablet. However, it can also retard disintegration of the tablet by forming a viscous gel when the tablet comes into contact with water. Thus, the presence of surfactant can make it more difficult to achieve both good strength and speed of disintegration: the problem has proved especially acute with tablets formed by compressing powders containing surfactant and built with insoluble detergency builder such as sodium aluminosilicate (zeolite).

It is known to include materials whose function is to enhance the speed of disintegration of tablets when placed in wash water. For example, our EP-A-838519 mentioned above teaches the use of sodium acetate trihydrate for this purpose.

A number of documents have taught that the disintegration of tablets of cleaning composition can be accelerated by incorporating in the tablet a quantity of a water-insoluble but water-swellable material serving to promote disintegration of the tablet when placed in water at the time of use. Examples are WO-98/40463 (Henkel) and WO-00/44870 and WO-A-98/55582 (both Unilever). EP-A-0-896 053 (Procter and Gamble Company) teaches that it is beneficial to include disintegrant materials in the coating of a tablet.

GB-2 339 575 A1 (Procter and Gamble Company) discloses detergent tablets comprising disintegrant granules comprising a cross-linked cellulose and optionally a wicking agent.

Except in the operating and comparative examples, or where otherwise explicitly indicated, all numbers in this description indicating amounts of material or conditions of reaction, physical properties of materials and/or use are to be understood as modified by the word “about.” All amounts are by weight, unless otherwise specified.

In a first aspect, the present invention provides a tablet of compacted particulate detergent composition comprising non-soap surfactant and detergency builder, wherein the tablet or a discrete region thereof comprises;

a) disintegration-promoting particles which comprise from 0.1 to 10% by weight of the particles of water-swellable, water-insoluble disintegrant material which is able to swell to at least twice its volume on contact with water, mixed with from 75 to 99.9 % by weight of the particles of a water-absorbent carrier material which does not swell to as much as twice its volume on contact with water, and

b) water-soluble polymeric binder which is solid at 25° C., and

c) 2 to 40% by weight of water-soluble disintegration-promoting particles comprising at least 40% (by weight of the particles) of one or more materials selected from the group consisting of;

compounds with water solubility in deionised water at 20° C. of at least 50 grams per 100 grams of water

phase I sodium tripolyphosphate

sodium tripolyphosphate which is partially hydrated so as to contain water of hydration in an amount which is at least 0.5% by weight of the sodium tripolyphosphate in the particles.

We have found that such swelling disintegrant particles (a) are effective to bring about tablet disintegration at the time of use, especially when used with the water-soluble disintegration-promoting particles.

However we have observed that such particles can be somewhat elastic, even while dry, and this can lead to a slow swelling and possibly breakage of the tablets prior to use. Also, it can necessitate the use of very high compaction force to make the tablets from particulate composition. Excessive force can create an impermeable surface skin on tablets, which impedes disintegration at the time of use.

Addition of polymeric binder (b) allows tablets to be made which are dimensionally stable in storage, and can be compacted without excessive force being required. The polymeric binder can be included in the disintegrant particles or used elsewhere in the overall particulate composition.

Thus, the polymeric binder may contribute only indirectly to the speed of disintegration, by facilitating the use of disintegrant particles which directly enhance tablet disintegration at the time of use.

We have observed a similar phenomenon with other swelling disintegrant particles. These too can be elastic while dry and lead to swelling of the tablets prior to use. The difficulty becomes more significant when making tablets with substantial strength, because very high compaction forces are required.

According to a second aspect of this invention there is provided a tablet of compacted particulate detergent composition comprising spray dried or agglomerated base particles comprising non-soap surfactant and detergency builder, wherein the tablet has a diametral fracture stress of at least 14 kPa, and wherein the tablet or a discrete region thereof comprises disintegration-promoting particles which swell on contact with water and which comprise water-swellable, water-insoluble material, admixed with the base particles, and further wherein the tablet comprises water-soluble polymeric binder which is solid at 25° C.

The diametral fracture stress of a cylindrical tablet is determined while the tablet is dry by using a test machine to apply compressive force to a tablet diameter (i.e. perpendicular to the axis of a cylindrical tablet). The force at fracture is noted. The diametral fracture stress in pascals is then calculated from the equation:

$$DFS = \frac{2 {F}_{max}}{π D t}$$

where Fₘₐₓ is the force in Newtons to cause fracture, D is the tablet diameter in meters and t is the tablet thickness in meters. The DFS is at least 14 kPa for the second aspect of this invention and preferred for the first aspect. For boht aspects of the invention the DFS is preferably at least 20 kPa. It may be 25 kPa or more.

If a tablet is not cylindrical, the diametral fracture stress is determined by testing a cylindrical tablet of identical composition compacted to the same density (and therefore the same porosity).

Tablets of either aspect of this invention may include particles of water-soluble salt. We have found that when water-swellable particles are included in a tablet composition, the presence of water-soluble salt can give a further increase in the speed of tablet disintegration. Tablets in commercial production have utilised such salts in substantial percentages, typically 18% by weight or more. We have found that good speeds of disintegration can be achieved by including a modest percentage of disintegrant particles as above and reducing the content of water-soluble disintegration-promoting salts to a much lower level, typically 8% by weight or less. Polymeric binder is also included—in accordance with this invention—to facilitate the incorporation of the disintegrant particles.

In a development of this invention we have found that the speed of disintegration of tablets can be increased further by spraying the polymeric binder onto the surface of other particles—especially particles which contain organic surfactant.

It is preferred that a composition to be compacted into tablets contains spray-dried or agglomerated base particles which incorporate both surfactant and detergency builder, and further particles which are mixed with these spray-dried or agglomerated base particles. These admixed particles include the disintegrant particles and may include separate particles of organic polymer.

A tablet of this invention may be either homogeneous or heterogeneous. In the present specification, the term “homogeneous” is used to mean a tablet produced by compaction of a single particulate composition, but does not imply that all the particles of that composition will necessarily be of identical composition. The term “heterogeneous” is used to mean a tablet consisting of a plurality of discrete regions, for example layers, inserts or coatings, each derived by compaction from a particulate composition. In a heterogeneous tablet according to the present invention, each discrete region of the tablet will preferably have a mass of at least 5 grams.

In a heterogeneous tablet, at least one and possibly more than one of the discrete regions contains the disintegrant particles required by this invention, together with water-soluble polymer.

This invention is particularly applicable to tablets for washing fabrics, containing at least 5% by weight of non-soap organic surfactant.

In a third aspect, this invention provides a process for making a tablet according to either aspect of the invention defined above, by mixing disintegrant particles with other constituents of a cleaning composition including organic surfactant and detergency builder, with water-soluble organic polymer present among the said particles or other constituents and then placing a quantity of the resulting particulate mixture within a mould and compacting it within the mould.

For homogeneous tablets the mixture will provide the whole contents of the mould. For heterogenous tablets another mixture may be placed in the mould before or after the first-mentioned mixture.

It is desirable that the compaction force applied does not create a pressure exceeding 35 MPa (which is slightly over 40 kN applied to a 40 mm diameter tablet) both to avoid excessive stress on the tableting machine and because excessive compaction pressure gives too much compaction of the surface layer of the tablet.

There are a number of materials which may be incorporated into tablets, as will now be described in more detail and exemplified.

Disintegration-promoting water-swellable particles

These particles contain a material which is water-swellable, but water-insoluble.

A number of water-insoluble, water-swellable materials are known to be useful as tablet disintegrants, in particular for pharmaceutical tablets. A discussion of such materials is found in “Drug Development and Industrial Pharmacy”, Volume 6, pages 511-536 (1980).

Suppliers of water-swellable disintegrant materials include J Rettenmaier & Söhne in Germany and FMC Corporation in USA.

Such swelling materials are mostly polymeric in nature and many of them are of natural origin. Materials which swell strongly are often chemically modified forms of natural materials such as Primojel™ or Explotab™ both of which are sodium starch glycolate (also known as sodium carboxymethyl starch); cellulose derivatives, for example Courlose™ and Nymcel™ sodium carboxymethyl cellulose, Ac-di-Sol™ cross-linked modified cellulose, and cross-linked cellulose. Various synthetic organic polymers can also swell strongly on contact with water.

In the first aspect of this invention, and optionally in the second aspect, the disintegrant particles also contain a carrier material which is capable of absorbing water. The carrier material may swell on contact with water.

It may be desirable that the carrier material does not swell to more than twice its volume on contact with water. By contrast the water swellable disintegrant material will generally swell to more than twice its volume, possibly to more than 2.5 or 3 times its volume, on contact with water.

The water-swellable disintegrant material may be a single substance or a mixture. If a carrier material is present, the disintegrant will generally be one or more materials which swell more than the carrier material on contact with water. It will generally be present in a smaller amount than the carrier material.

We have found that disintegrant particles which contain a high proportion of material able to swell to several times its volume are excessively elastic. By contrast, disintegrant particles which contain a minority of such material mixed with a majority of carrier which does not swell so much, can provide effective disintegration, and, more stability of the tablet between manufacture and use. Preferred disintegrant particles contain from 75% or 90% up to 99.9% by weight of a carrier material which does not swell to more than double its volume on contact with water, together with from 0.1% or 2% to 10% by weight of water-insoluble material which swells on contact with water to more than twice, possibly more than three or four times its volume. Other materials are present as necessary to make up the remainder of the mass of the granule.

An apparatus for measuring increase in volume is illustrated in “The Mechanisms of Disintegrant Action”. Kanic & Rudnic, Pharmaceutical Technology, April 1984, pages 50-63. This article also refers to papers describing other apparatus.

Another parameter which characterises swellable materials is the force which they exert if they are allowed to take up water whilst confined within an enclosure.

We have found that materials and particles which swell on contact with water are effective as disintegrants if there is a rapid development of force when they come into contact with water.

We have carried out measurements using a relatively simple piece of apparatus shown in the attached drawing and an Instron materials testing machine type 5566 from Instron, UK (herein after referred to as “the Instron machine”).

The apparatus consists of a cylinder (10) with internal diameter 25 mm and a length of 20 mm. This cylinder is perforated by a ring of holes (12) adjacent one end. There are 36 of these holes, of 1 mm diameter, with centres 2.5 mm from the end of the cylinder.

This end of the cylinder is glued to the base of a glass container (14) of internal diameter 73 mm.

To test a sample of powdered disintegrant, 1.5 gram of the disintegrant is placed in the cylinder and gently tapped so that it forms a level bed (16) which is usually 6 mm to 10 mm deep depending on the bulk density of the powder. A plunger (18) of the Instron machine is moved into the upper set of the cylinder, over this powder bed.

Under computer control of the Instron machine the plunger is applied to the top of the powder bed (16) with a force of 1 Newton.

50 ml of distilled water at 22° C. is tipped into the annular space (20) around the cylinder. This water passes through the holes (12) into the powder bed. The Instron machine is programmed to hold the plunger in position against the swelling bed of powder, and the force required for this is recorded.

It is preferred that a strongly swelling material, if tested, by itself, has ability to absorb at least twice its own volume of water and has a development of expansion force which exceeds 1.5 Newton/second.

The development of swelling force has been measured for a number of materials, as set out in the following table.

| | | Disintegrating |
|---|---|---|
| | | force |
| | | development |
| Trade Name | Chemical Nature | rate (N/sec) |
| | Maize starch | 1.1 |
| Explotab | Na-carboxy methyl starch | 2.0 |
| | ex. Mendell Co | |
| Primojel | Na-carboxy methyl starch | 2.2 |
| | ex Avebe | |
| Avicel PH | Micro crystalline | 0.6 |
| 101 | cellulose ex. FMC | |
| L-HPC | Low substituted hydroxy | 2.2 |
| | propyl cellulose ex. | |
| | Shin-Etsu Japan | |
| Ac-di-Sol | Cross-linked SCMC ex FMC | 3.5 |
| Polyplasdone | Cross-linked PVP ex. ISP | 4.3 |
| XL | | |
| Amberlite | K-salt of methacrylic | 5.0 |
| IRP 88 | acid cross-linked with | |
| | divinylbenzene ex. Rohm & | |
| | Haas | |
| Plas-Vita | Co-polymer of formalin | 3.1 |
| | and casein ex. Eigenmann- | |
| | Veronelli | |

The significant parameter is the maximum slope of a graph of expansion force against time.

Measurement of swelling can be recorded with the same apparatus. The plunger is again applied to the top of a bed of the dry powder, and pressed against it with a force of 1 Newton. 50 ml of water is poured in as before. The Instron machine is programmed to allow expansion of the bed of powder, while maintaining a force on it of 1 Newton. Displacement of the plunger is recorded.

A strongly swelling material may come from a category referred to as a super-disintegrant. Such super-disintegrant tend to be cross-linked synthetic or natural polymers and include cross-linked forms of carboxymethyl cellulose, cellulose, starch, polyvinylpyrrolidone and polyacrylate.

A carrier material is preferably selected from compounds which contain hydroxy groups.

A carrier material may itself be a water-insoluble, and somewhat water-swellable material. Such materials include starches, for example, maize, rice and potato starches, celluloses, for example, Arbocel®-B and Arbocel®-BC (beech cellulose), Arbocel®-BE (beech-sulphite cellulose), Arbocel®-B-SCH (cotton cellulose), Arbocel®-FIC (pine cellulose) as well as further Arbocel® types from Rettenmaier, microcrystalline cellulosic fibres and some synthetic organic polymers.

Cellulose-containing fibrous materials originating from timber may be compacted wood pulps. So-called mechanical pulps generally incorporate lignin as well as cellulose whereas chemical pulps generally contain cellulose but little of the original lignin remains. Pulp obtained by a mixture of chemical and mechanical methods may retain some but not all of the original lignin. Cellulose based materials include Nylin LX-16 which is a water-insoluble compacted cellulose based disintegrant, commercially available from FMC Corporation.

The disintegrant particles may be made by mixing the swellable disintegrant with the carrier material, then compacting the mixture, and if necessary comminuting the compacted mixture into disintegrant particles. Preferably these have a particle size in a range from 250 to 1000 or 1500 microns.

Mixing of these materials can be carried out by standard apparatus for mixing particulate solids. Other ingredients can be incorporated at this stage. If a polymeric binder is incorporated, it can be added in particulate form during this mixing operation. Alternatively, if it can be melted, the molten polymer can be sprayed on to the mixture or on to one particulate ingredient of the mixture.

Compaction of the mixture can be brought about by forcing it between a pair or rollers. Suitable apparatus—a roller compactor—has a feed screw which delivers the mixture to the nip of the rollers. The speed of the feed screw, and hence the amount of material delivered to the nip of the rollers should be high enough to force an unbroken stream of material through the rollers, but not so high that the material is converted into a dough.

The sheet of material which issues from the rollers is next broken up and milled to the required particle size.

Manufacturers of both roller compactor and milling machinery include Hosokawa Beper located at Heilbromn, Germany, Alexanderwerk located at Remschied, Germany and Fitzpatrick located at Elmhurst, USA.

The overall quantity of water swellable disintegrant particles in the tablet is preferably between 0.1 and 20% by weight of the tablet.

Water-soluble organic polymer binder

The water-soluble organic polymeric binder is solid at 25° C.

It is preferred that the polymer material should melt at a temperature of at least 35° C., better 40° C. or above, which is above the range of ambient temperatures in many temperate countries. For use in hotter countries it will be preferably that the melting temperature is somewhat above 40° C., so as to be above the ambient temperature.

Some polymers which may be used are solids at temperatures up to 100° C., that is to say they retain a solid appearance even though they are in an amorphous state. They may soften and melt to a mobile liquid on heating further, or may decompose without melting on heating sufficiently in excess of 100° C. Such polymers will generally be added as a powder during the course of granulation. Another possibility would be addition as a solution in a volatile organic solvent, but that is not preferred.

Other polymers which may be used melt to liquid form at temperatures not exceeding 80° C. and may be sprayed as molten liquid onto the surfactant and builder mixture during the course of granulation.

Organic polymers are in general amorphous solids. A significant parameter characterising amorphous solids is their glass transition temperature. When an amorphous hydrophilic polymer absorbs moisture, the moisture acts as a plasticiser and lowers the glass transition temperature of the polymer. Suitable polymers may have a glass transition temperature, when anhydrous, which is from 300 to 500 K (i.e. approximately 25° C. to 225° C.) but may be incorporated in a moisture-containing state so that their glass transition temperature is lower.

Preferred polymer materials are synthetic organic polymers especially polyethylene glycol. Polyethylene glycol of average molecular weight 1500 (PEG 1500) melts at 45° C. and has proved suitable. Polyethylene glycol of higher molecular weight can also be used (PEG 4000 melts at 56° C. and PEG 6000 at 58° C.).

Other possibilities are polyvinylpyrrolidone, and polyacrylate and water-soluble acrylate copolymers.

The amount of water-soluble polymer included in the composition of the tablet or region thereof, is desirably between 0.2% or 1% up to 10% or 15% by weight, more preferably at least 0.5 or 2% by weight. Possibly the amount of polymer does not exceed 7% by weight of the whole composition.

If organic polymer is incorporated into the disintegrant particles themselves, it may be possible to use the polymer in an amount which is a small percentage of the whole composition of the tablet or region thereof, e.g. 0.1 to 1% .

If further water-soluble polymer is incorporated into the composition as a separate ingredient, i.e. not in particles with organic surfactant and detergency builder, the total amount present should desirably fall within the limits expressed above for the whole composition of the tablet or region thereof.

Surfactant compounds

Compositions which are compacted to form tablets or regions of tablet may contain one or more organic detergent surfactants. In a fabric washing composition, these preferably provide from 5 to 50% by weight of the overall tablet composition, more preferably from 8 or 9% by weight of the overall composition up to 40%, 49% or 50% by weight. Surfactant may be anionic (soap or non-soap), cationic, zwitterionic, amphoteric, nonionic or a combination of these.

Anionic surfactant may be present in an amount from 0.5 to 50% by weight, preferably from 2% or 4% up to 30% or 40% by weight of the tablet composition.

In a machine dishwashing composition, organic surfactant is likely to constitute from 0.5% or 1% to 8% by weight, more likely from 0.5 to 4.5% by weight of the overall composition and is likely to consist of nonionic surfactant, either alone or in a mixture with anionic surfactant.

Synthetic (i.e. non-soap) anionic surfactants are well known to those skilled in the art. Examples include alkylbenzene sulphonates, particularly sodium linear alkylbenzene sulphonates having an alkyl chain length of C₈-C₁₅; olefin sulphonates; alkane sulphonates; dialkyl sulphosuccinates; and fatty acid ester sulphonates.

Primary alkyl sulphate having the formula:

ROSO₃⁻M⁺

in which R is an alkyl or alkenyl chain of 8 to 18 carbon atoms especially 10 to 14 carbon atoms and M⁺is a solubilising cation, is commercially significant as an anionic surfactant.

Linear alkyl benzene sulphonate of the formula:

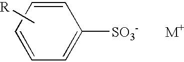

where R is linear alkyl of 8 to 15 carbon atoms and M⁺is a solubilising cation, especially sodium, is also a commercially significant anionic surfactant.

Frequently, such linear alkyl benzene sulphonate or primary alkyl sulphate of the formula above, or a mixture thereof will be the desired anionic surfactant and may provide 75 to 100 wt % of any anionic non-soap surfactant in the composition.

In some forms of this invention the amount of non-soap anionic surfactant lies in a range from 5 to 20 or 25 wt % of the tablet composition.

It may also be desirable to include one or more soaps of fatty acids. These are preferably sodium soaps derived from naturally occurring fatty acids, for example, the fatty acids from coconut oil, beef tallow, sunflower or hardened rapeseed oil.

Suitable nonionic surfactant compounds which may be used include in particular the reaction products of compounds having a hydrophobic group and a reactive hydrogen atom, for example, aliphatic alcohols, acids, amides or alkyl phenols with alkylene oxides, especially ethylene oxide.

Specific nonionic surfactant compounds are alkyl (C₈₋₂₂) phenol-ethylene oxide condensates, the condensation products of linear or branched aliphatic C₈₋₂₀ primary or secondary alcohols with ethylene oxide, and products made by condensation of ethylene oxide with the reaction products of propylene oxide and ethylene-diamine.

Especially preferred are the primary and secondary alcohol ethoxylates, especially the C₉₋₁₁ and C₁₂₋₁₅ primary and secondary alcohols ethoxylated with an average of from 5 to 20 moles of ethylene oxide per mole of alcohol. It is desirable that alkoxylation is carried out with ethylene oxide only, so that the resulting mixture of compounds complies with a general formula:

RₚO(C₂H₄O)_{q}H

where p has a mean value of 6 to 15 and q has a mean value of 5 to 20, preferably 5 to 9.

In certain forms of this invention the amount of nonionic surfactant lies in a range from 4 to 40%, better 4 or 5 to 30% by weight of the composition. Many nonionic surfactants are liquids. These may be absorbed onto particles of the composition, prior to compaction into tablets.

Amphoteric surfactants which may be used jointly with anionic or nonionic surfactants or both include amphopropionates of the formula:

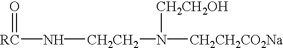

where RCO is a acyl group of 8 to 18 carbon atoms, especially coconut acyl.

The category of amphoteric surfactants also includes amine oxides and also zwitterionic surfactants, notably betaines of the general formula:

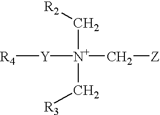

where R₄ is an aliphatic hydrocarbon chain which contains 7 to 17 carbon atoms, R₂ and R₃ are independently hydrogen, alkyl of 1 to 4 carbon atoms or hydroxyalkyl of 1 to 4 carbon atoms such as CH₂OH, Y is CH₂ or of the form CONHCH₂CH₂CH₂ (amidopropyl betaine); Z is either a COO⁻(carboxybetaine), or of the form CHOHCH₂SO₃—(sulfobetaine or hydroxy sultaine).

Another example of amphoteric surfactant is amine oxide of the formula:

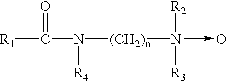

where R₁ is C₁₀ to C₂₀ alkyl or alkenyl; R₂, R₃ and R₄ are each hydrogen or C₁ to C₄ alkyl, while n is from 1 to 5.

Cationic surfactants may possibly be used. These frequently have a quaternised nitrogen atom in a polar head group and an attached hydrocarbon group of sufficient length to be hydrophobic.

A general formula for one category of cationic surfactants is:

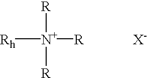

where each R independently denotes an alkyl group or hydroxyalkyl group of 1 to 3 carbon atoms and Rₕ denotes an aromatic, aliphatic or mixed aromatic and aliphatic group of 6 to 24 carbon atoms, preferably an alkyl or alkenyl group of 8 to 22 carbon atoms and X⁻ is a counterion.

The amount of amphoteric surfactant, if any, may possibly be from 3% to 20 or 30% by weight of the tablet or region of a tablet; the amount of cationic surfactant, if any, may possibly be from 1% to 10 or 20% by weight of the tablet or region of a tablet.

Water-softening agent

A composition which is compacted to form tablets or tablet regions may contain a so-called water-softening agent which serves to remove or sequester calcium and/or magnesium ions in the water. In the context of a detergent composition containing organic surfactant, a water-softening agent is more usually referred to as a detergency builder.

When a water-softening agent is present, the amount of it is likely to lie in a broad range from 5 better 15 wt % up to 98% of the tablet composition. In detergent tablets the amount is likely to be from 15 to 80%, more usually 15 to 60% by weight of the tablet. Amounts of 5 to 98% by weight of water-insoluble detergency builder or 10 to 80% by weight water-soluble detergency builder are preferred.

Water-softening agents may be provided wholly by water soluble materials, or may be provided in large part or even entirely by water-insoluble material with water-softening properties.

Alkali metal aluminosilicates are strongly favoured as environmentally acceptable water-insoluble softening agents (detergency builders) for fabric washing. Alkali metal (preferably sodium) aluminosilicates may be either crystalline or amorphous or mixtures thereof, having the general formula:

0.8−1.5 Na₂O.Al₂O₃.0.8−6 SiO_{2.} xH₂O

These materials contain some bound water (indicated as xH₂O) and are required to have a calcium ion exchange capacity of at least 50 mg CaO/g. The preferred sodium aluminosilicates contain 1.5-3.5 SiO₂ units (in the formula above). Both the amorphous and the crystalline materials can be prepared readily by reaction between sodium silicate and sodium aluminate, as amply described in the literature.

Suitable crystalline sodium aluminosilicate ion-exchange materials are described, for example, in GB 1429143 (Procter & Gamble). The preferred sodium aluminosilicates of this type are the well known commercially available zeolites A and X, the newer zeolite P described and claimed in EP 384070 (Unilever) and mixtures thereof. This form of zeolite P is also referred to as “zeolite MAP”. One commercial form of it is denoted “zeolite A24”.

Conceivably a water-insoluble water-softener (detergency builder) could be a layered sodium silicate as described in U.S. Pat. No. 4,664,839. NaSKS-6 is the trademark for a crystalline layered silicate marketed by Hoechst (commonly abbreviated as “SKS-6”). NaSKS-6 has the delta-Na₂SiO₅ morphology form of layered silicate. It can be prepared by methods such as described in DE-A-3,417,649 and DE-A-3,742,043. Other such layered silicates, such as those having the general formula NaMSiₓO_{2x+1.}yH₂O wherein M is sodium or hydrogen, x is a number from 1.9 to 4, preferably 2, and y is a number from 0 to 20, preferably 0 can be used.

The category of water-soluble phosphorus-containing inorganic softeners includes the alkali-metal orthophosphates, metaphosphates, pyrophosphates and polyphosphates. Specific examples of inorganic phosphate detergency builders include sodium and potassium tripolyphosphates, orthophosphates and hexametaphosphates.

Non-phosphorus water-soluble water-softening agents may be organic or inorganic. Inorganics that may be present include alkali metal (generally sodium) carbonate; while organics include polycarboxylate polymers, such as polyacrylates, acrylic/maleic copolymers, and acrylic phosphonates, monomeric polycarboxylates such as citrates, gluconates, oxydisuccinates, glycerol mono- di- and trisuccinates, carboxymethyloxysuccinates, carboxymethyloxymalonates, dipicolinates and hydroxyethyliminodiacetates.

Tablet compositions preferably include polycarboxylate polymers, more especially polyacrylates and acrylic/maleic copolymers which have some function as water-softening agents and also inhibit unwanted deposition onto fabric from the wash liquor.

Bleach system

Tableted compositions according to the invention may contain a bleach system. This preferably comprises one or more peroxy bleach compounds, for example, inorganic persalts or organic peroxyacids, which may be employed in conjunction with activators to improve bleaching action at low wash temperatures. If any peroxygen compound is present, the amount is likely to lie in a range from 10 to 85% by weight of the composition. If the tablet contains surfactant and detergency builder, the amount of peroxygen compound bleach is unlikely to exceed 25% of the composition.

Preferred inorganic persalts are sodium perborate monohydrate and tetrahydrate, and sodium percarbonate, advantageously employed together with an activator. Bleach activators, also referred to as bleach precursors, have been widely disclosed in the art. Preferred examples include peracetic acid precursors, for example, tetraacetylethylene diamine (TAED), now in widespread commercial use in conjunction with sodium perborate; and perbenzoic acid precursors. The quaternary ammonium and phosphonium bleach activators disclosed in U.S. Pat. No. 4,751,015 and U.S. Pat. No. 4,818,426 (Lever Brothers Company) are also of interest. Another type of bleach activator which may be used, but which is not a bleach precursor, is a transition metal catalyst as disclosed in EP-A-458397, EP-A-458398 and EP-A-549272. A bleach system may also include a bleach stabiliser (heavy metal sequestrant) such as ethylenediamine tetramethylene phosphonate and diethylenetriamine pentamethylene phosphonate.

Water-soluble disintegration-promoting particles

A tablet or a region of a tablet contains water-soluble particles to promote disintegration according to the first aspect of the invention and may contain such particles according to the second aspect of the invention. These are in addition to the water-insoluble, water-swellable, disintegrant particles required by this invention.

Such soluble particles typically comprise at least 40% (of their own weight) of one or more materials selected from;

compounds with a water-solubility of at least 50 grams per 100 grams water

phase I sodium tripolyphosphate

sodium tripolyphosphate which is partially hydrated so as to contain water of hydration in an amount which is at least 0.5% by weight of the sodium tripolyphosphate in the particles.

As will be explained further below, these disintegration-promoting particles can also contain other forms of tripolyphosphate or other salts within the balance of their composition.

If the material in such water-soluble disintegration-promoting particles can function as a detergency builder, (as is the case with sodium tripolyphosphate) then of course it contributes to the total quantity of detergency builder in the tablet composition.

The quantity of water-soluble disintegration-promoting particles may be from 2, 3 or 5% up to 28, 30 or 40% by weight of the tablet or region thereof. The quantity may possibly be from 8% up to 25 or 30% or more. However, it is within this invention that the amount of such water-soluble disintegration-promoting particles is low, below 5% by weight of the tablet or region, reliance being placed on water insoluble, water swellable particles.

One possibility is that these particles contain at least 40% of their own weight, better at least 50%, of a material which has a solubility in deionised water at 20° C. of at least 50 grams per 100 grams of water.

These particles may provide material of such solubility in an amount which is at least 7 wt % or 12 wt % of the composition of the tablet or discrete region thereof.

A solubility of at least 50 grams per 100 grams of water at 20° C. is an exceptionally high solubility: many materials which are classified as water soluble are less soluble than this.

Some highly water-soluble materials which may be used are listed below, with their solubilities expressed as grams of solid to form a saturated solution in 100 grams of water at 20° C.:—

| Material | Water Solubility (g/100 g) |
|---|---|
| Sodium citrate dihydrate | 72 |
| Potassium carbonate | 112 |
| Urea | >100 |
| Sodium acetate | 119 |
| Sodium acetate trihydrate | 76 |
| Magnesium sulphate 7H₂0 | 71 |

By contrast the solubilities of some other common materials at 20° C. are:—

| Material | Water Solubility (g/100 g) |
|---|---|
| Sodium chloride | 36 |
| Sodium sulphate decahydrate | 21.5 |
| Sodium carbonate anhydrous | 8.0 |
| Sodium percarbonate anhydrous | 12 |
| Sodium perborate anhydrous | 3.7 |
| Sodium tripolyphosphate anhydrous | 15 |

Preferably this highly water soluble material is incorporated as particles of the material in a substantially pure form (i.e. each such particle contains over 95% by weight of the material). However, the said particles may contain material of such solubility in a mixture with other material, provided that material of the specified solubility provides at least 40% by weight of these particles.

A preferred material is sodium acetate in a partially or fully hydrated form.

It may be preferred that the highly water-soluble material is a salt which dissolves in water in an ionised form. As such a salt dissolves it leads to a transient local increase in ionic strength which can assist disintegration of the tablet by preventing nonionic surfactant from swelling and inhibiting dissolution of other materials.

Another possibility is that the said particles which promote disintegration are particles containing sodium tripolyphosphate with more than 40% (by weight of the particles) of the anhydrous phase I form.

Sodium tripolyphosphate is very well known as a sequestering builder in detergent compositions. It exists in a hydrated form and two crystalline anhydrous forms. These are the normal crystalline anhydrous form, known as phase II which is the low temperature form, and phase I which is stable at high temperature. The conversion of phase II to phase I proceeds fairly rapidly on heating above the transition temperature, which is about 420° C., but the reverse reaction is slow. Consequently phase I sodium tripolyphosphate is metastable at ambient temperature.

A process for the manufacture of particles containing a high proportion of the phase I form of sodium tripolyphosphate by spray drying below 420° C. is given in U.S. Pat. No. 4,536,377.

Particles which contain this phase I form will often contain the phase I form of sodium tripolyphosphate as at least 50% or 55% by weight of the tripolyphosphate in the particles.

Suitable material is commercially available. Suppliers include Rhone-Poulenc, France and Albright & Wilson, UK.

The water-soluble disintegration-promoting particles may contain at least 40 wt % (by weight of the particles) of sodium tripolyphosphate which is partially hydrated. The extent of hydration should be at least 0.5% by weight of the sodium tripolyphosphate in the particles. It may lie in a range from 0.5 to 4% by weight, or it may be higher. Indeed fully hydrated sodium tripolyphosphate may be used to provide these particles.

It is possible that the particles contain at least 40 wt % sodium tripolyphosphate which has a high phase I content but is also sufficiently hydrated so as to contain at least 0.5% water by weight of the sodium tripolyphosphate.

The remainder of the tablet composition used to form the tablet or region thereof may include additional sodium tripolyphosphate. This may be in any form, including sodium tripolyphosphate with a high content of the anhydrous phase II form.

Other Ingredients

Tablets may also contain one of the detergency enzymes well known in the art for their ability to degrade and aid in the removal of various soils and stains. Suitable enzymes include the various proteases, cellulases, lipases, amylases, and mixtures thereof, which are designed to remove a variety of soils and stains from fabrics. Examples of suitable proteases are Maxatase (Trade Mark), as supplied by Gist-Brocades N.V., Delft, Holland, and Alcalase (Trade Mark), and Savinase (Trade Mark), as supplied by Novo Industri A/S, Copenhagen, Denmark. Detergency enzymes are commonly employed in the form of granules or marumes, optionally with a protective coating, in amount of from about 0.1% to about 3.0% by weight of the composition; and these granules or marumes present no problems with respect to compaction to form a tablet.

Tablets may also contain a fluorescer (optical brightener), for example, Tinopal (Trade Mark) DMS or Tinopal CBS available from Ciba-Geigy AG, Basel, Switzerland. Tinopal DMS is disodium 4,4′bis-(2-morpholino-4-anilino-s-triazin-6-ylamino) stilbene disulphonate; and Tinopal CBS is disodium 2,2′-bis-(phenyl-styryl) disulphonate.

An antifoam material is advantageously included if organic surfactant is present, especially if a detergent tablet is primarily intended for use in front-loading drum-type automatic washing machines. Suitable antifoam materials are usually in granular form, such as those described in EP 266863A (Unilever). Such antifoam granules typically comprise a mixture of silicone oil, petroleum jelly, hydrophobic silica and alkyl phosphate as antifoam active material, sorbed onto a porous absorbed water-soluble carbonate-based inorganic carrier material. Antifoam granules may be present in an amount up to 5% by weight of the composition.

It may also be desirable that a tablet includes an amount of an alkali metal silicate, particularly sodium ortho-, meta- or disilicate. The presence of such alkali metal silicates at levels, for example, of 0.1 to 10 wt %, may be advantageous in providing protection against the corrosion of metal parts in washing machines, besides providing some measure of building and giving processing benefits in manufacture of the particulate material which is compacted into tablets. A composition for fabric washing will generally not contain more than 15 wt % silicate. A tablet for machine dishwashing will frequently contain at least 20 wt % silicate.

Further ingredients which can optionally be employed in fabric washing detergent tablets of the invention include anti-redeposition agents such as sodium carboxymethylcellulose, straight-chain polyvinyl pyrrolidone and the cellulose ethers such as methyl cellulose and ethyl hydroxyethyl cellulose, fabric-softening agents; heavy metal sequestrants such as EDTA; perfumes; and colorants or coloured speckles.

Particle Size and Distribution

A tablet of this invention, or a discrete region of such a tablet, is a matrix of compacted particles.

Preferably the particulate composition has an average particle size in the range from 200 to 2000 μm, more preferably from 250 to 1400 μm. Fine particles, smaller than 180 μm or 200 μm may be eliminated by sieving before tableting, if desired, although we have observed that this is not always essential.

While the starting particulate composition may in principle have any bulk density, the present invention may be especially relevant to tablets of detergent composition made by compacting powders of relatively high bulk density, because of their greater tendency to exhibit disintegration and dispersion problems. Such tablets have the advantage that, as compared with a tablet derived from a low bulk density powder, a given dose of composition can be presented as a smaller tablet.

Thus the starting particulate composition may suitably have a bulk density of at least 400 g/liter, preferably at least 500 g/liter, and possibly at least 600 g/liter.

A composition which is compacted into a tablet or tablet region may contain particles which have been prepared by spray-drying or granulation and which contain a mixture of ingredients. Such particles may contain organic detergent surfactant and some or all of the water-softening agent (detergency builder) which is also present in a detergent tablet.

Granular detergent compositions of high bulk density may be prepared by granulation and densification in a high-speed mixer/granulator, as described and claimed in EP 340013A (Unilever), EP 352135A (Unilever), and EP 425277A (Unilever), or by the continuous granulation/densification processes described and claimed in EP 367339A (Unilever) and EP 390251A (Unilever).

Another suitable granulation process is described in WO 00/77147 (Unilever). A liquid binder is contacted with a solid starting material in a high-speed mixer and the resulting mixture is treated in a medium or low speed mixer and finally in a gas fluidisation granulator, where more liquid binder is added.

Product forms and proportions

A tablet according to the third aspect of the present invention may especially be embodied as a tablet for fabric washing. Such a tablet will generally contain, overall, from 5 to 50% by weight of surfactant and from 5 to 80% by weight of detergency builder which is a water softening agent. Water-soluble disintegration promoting particles may be present in an amount from 5% to 25% by weight of the composition. Peroxygen bleach may be present and if so is likely to be in an amount not exceeding 25% by weight of the total composition.

The invention may be embodied as tablets whose principal or sole function is that of removing water hardness. In such tablets the water-softening agents, especially water-insoluble aluminosilicate, may provide from 50 to 98% by weight of the tablet composition. A water-soluble supplementary builder may well be included, for instance in an amount from 2% to 30 wt % of the composition, or may be considered unnecessary and not used.

Tablets according to the invention may comprise from 1 to 5% by weight of surfactant, from 0.1 to 20% by weight of said water-swellable disintegration-promoting particles and from 50 to 98% by weight of detergency builder, especially if they are for use as water-softening tablets or dishwashing tablets.

Water-softening tablets may include some surfactant.

The invention may be embodied as tablets for machine dishwashing. Such tablets typically contain a high proportion of water soluble salts, such as 50 to 95% by weight, at least some of which, exemplified by sodium citrate and sodium silicate, have water-softening properties.

Both water-softening and machine dishwashing tablets may include nonionic surfactant which can act as a lubricant during tablet manufacture and as a low foaming detergent during use. The amount may be small, e.g. from 0.2 or 0.5% by weight of the composition up to 3% or 5% by weight.

Tablets for use as a bleaching additive will typically contain a high proportion of peroxygen bleach, such as 25 to 85% by weight of the composition. This may be mixed with other soluble salt as a diluent. The composition of such a tablet may well include a bleach activator such as tetraacetylethylene diamine (TAED). A likely amount would lie in the range from 1 to 20% by weight of the composition.

Tableting

Tableting entails compaction of a particulate composition. A variety of tableting machinery is known, and can be used. Generally it will function by stamping a quantity of the particulate composition which is confined in a die.

The mould in which the tablet is formed may be provided by an aperture within a rigid structure (that is a rigid structure surrounding a cavity) and a pair of dies (punches) which are moveable towards each other within the cavity, thereby compacting the contents of the aperture. A tableting machine may have a rotary table defining a number of apertures each with a pair or associated dies which can be driven into an apertures. Each die may be provided with an elastomeric layer on its surface which contacts the tablet material, as taught in WO 98/46719 or WO 98/46720.

Tableting may be carried out at ambient temperature or at a temperature above ambient which may allow adequate strength to be achieved with less applied pressure during compaction. In order to carry out the tableting at a temperature which is above ambient, the particulate composition is preferably supplied to the tableting machinery at an elevated temperature. This will of course supply heat to the tableting machinery, but the machinery may be heated in some other way also.

If any heat is supplied, it is envisaged that this will be supplied conventionally, such as by passing the particulate composition through an oven, rather than by any application of microwave energy.

The mass of a tablet will suitably range from 10 to 160 grams, preferably from 15 to 60 g, depending on the conditions of intended use, and whether it represents a dose for an average load in a fabric washing or dishwashing machine or a fractional part of such a dose. The tablets may be of any shape. However, for ease of packaging they are preferably blocks of substantially uniform cross-section, such as cylinders or cuboids. The overall density of a tablet for fabric washing preferably lies in a range from 1040 or 1050 g/liter preferably at least 1100 g/liter up to 1400 g/liter. The tablet density may well lie in a range up to no more than 1350 or even 1250 g/liter. The overall density of a tablet of some other cleaning composition, such as a tablet for machine dishwashing or as a bleaching additive, may range up to 1700 g/liter and will often lie in a range from 1300 to 1550 g/liter. The invention will be further described by reference to the following examples. Further examples within the scope of the present invention will be apparent to the person skilled in the art.

### EXAMPLE 1

Detergent base powder, incorporating organic surfactants and detergency builder was made using the process described in WO-A-98/11193. The powder had the following compositions. Amounts are shown both as weight percentages of the base powder and as parts by weight.

| | | Parts by |
|---|---|---|
| Ingredient | (wt %) | Weight |
| Sodium linear alkylbenzene | 23.60 | 10.15 |
| sulphonate | | |
| Nonionic surfactant (C13-15 | 7.05 | 3.03 |
| branched fatty alcohol 7EO) | | |
| Soap | 1.65 | 0.71 |
| Zeolite A24 (Zeolite MAP ex | 40.61 | 17.46 |
| Crosfields) | | |
| Sodium acetate trihydrate | 10.21 | 4.39 |
| Sodium carbonate | 4.97 | 2.14 |
| Linear sodium carboxymethyl | 0.92 | 0.40 |
| cellulose (SCMC) | | |
| Sodium citrate | 3.06 | 1.32 |
| Linear sodium sulphate, moisture | 7.93 | 3.41 |
| and minor ingredients | | |
| Total | 100 | 43 |

The amount of zeolite MAP (zeolite A24) in the table above is the amount which would be present if it was anhydrous. Its accompanying small content of moisture is included as part of the moisture and minor ingredients. Linear sodium carboxymethyl cellulose is a commonly used water soluble antiredeposition polymer.

Disintegrant particles were provided by a natural cellulosic material (a by-product obtained after separating coir fibres from coconut husk). This material was observed to swell to more than twice its volume when placed in contact with water.

Further disintegrant particles were made from about 95% by weight microcrystalline cellulose as carrier and 5% by weight cross-linked carboxymethyl cellulose as swellable disintegrant with a balance of soluble salt. When microcrystalline cellulose comes into contact with water, it expands to about 1.5 times its dry volume.

Cross-linked carboxymethyl cellulose expands considerably when brought into contact with water, swelling to approximately 3 times it original dry volume.

This combination of materials was supplied by FMC Corporation under designation “Nylin LX-16”.

Particulate compositions were made using base powder as above, either type of disintegrant particles as above, PEG 1500 in the form of powder of average particle size 150 micrometers and various particulate ingredients as follows:

| Ingredients | % by weight | | | | |
|---|---|---|---|---|---|
| Composition | A | B | C | D | E |
| Base Powder | 43 | 43 | 43 | 43 | 43 |
| Sodium percarbonate | 15.0 | 15.0 | 15.0 | 15.0 | 15.0 |
| coated with sodium | | | | | |
| chloride | | | | | |
| TAED granules | 5.0 | 5.0 | 5.0 | 5.0 | 5.0 |
| Anti-foam granules | 1.7 | 1.7 | 1.7 | 1.7 | 1.7 |
| Soil-release polymer | 1.0 | 1.0 | 1.0 | 1.0 | 1.0 |
| Fluorescer granules | 1.2 | 1.2 | 1.2 | 1.2 | 1.2 |
| Sodium silicate | 3.1 | 3.1 | 3.1 | 3.1 | 3.1 |
| granules | | | | | |
| Acrylate/maleate | 1.0 | 1.0 | 1.0 | 1.0 | 1.0 |
| copolymer | | | | | |
| Sodium acetate | 23 | 23 | 23 | 23 | 23 |
| trihydrate | | | | | |
| Blue speckles and | 2.0 | 2.0 | 2.0 | 2.0 | 2.0 |
| heavy metal | | | | | |
| sequestrants | | | | | |
| Coconut-derived | 4 | 4 | 4 | 0 | 0 |
| disintegrants | | | | | |
| Nylin LX-16 | 0 | 0 | 0 | 3.5 | 3.5 |
| PEG 1500 | 0 | 3 | 4.5 | 1.8 | 3.6 |
| Total | 100 | 103 | 104.5 | 101.3 | 103.1 |

The resulting compositions were compacted using a commercial scale Fette rotary tablet press operated with sufficient pressure to compact 42.5 gram portions of the compositions into cylindrical tablets with a diameter of 44 mm and a thickness of 20 to 21 mm.

The strength of the tablets, in their dry state as made on the press, was determined as their diametrical fracture stress DFS, which calculated from the equation given earlier:

$$DFS = \frac{2 {F}_{max}}{π D t}$$

where DFS is the diametrical fracture stress in Pascals, Fₘₐₓ is the applied load in Newtons to cause fracture, D is the tablet diameter in meters and t is the tablet thickness in meters. The test is carried out using an Instron type universal testing instrument to apply progressively increasing compressive force on a tablet diameter (i.e. perpendicular to the axis of a cylindrical tablet).

The testing machine also recorded the displacement towards each other of its platens bearing on the tablet, as the force is increased until the tablet fractures.

The break energy E_{b} of the tablets was determined as the area under a graph applied compressive force against displacement, up to the point of break, as described in our WO-A-98/42817. The results are shown below.

| Composition | 1A | 1B | 1C | 1D | 1D | 1E | 1E |
|---|---|---|---|---|---|---|---|
| Coconut derived | 4 | 4 | 4 | | | | |
| disintegrant (%) | | | | | | | |
| Nylin LX 16 (%) | | | | 3.5 | 3.5 | 3.5 | 3.5 |
| PEG 1500 (%) | 0 | 3 | 4.5 | 1.8 | 1.8 | 3.6 | 3.6 |
| Compaction force | 44.7 | 27.4 | 27.7 | 11.6 | 14.9 | 7.8 | 11 |
| (kN) | | | | | | | |
| Force at fracture | 25 | 24.3 | 39.7 | 27.7 | 39.1 | 26.9 | 38.3 |
| Fₘₐₓ (N) | | | | | | | |
| Calculated DFS (kPa) | 18.0 | 17.6 | 28.7 | 20.0 | 28.3 | 19.5 | 27.7 |
| Break energy Ebr (mJ) | | 14.1 | 20 | 9.7 | 12.7 | 9.1 | 13.3 |

For calculation of DFS, thickness was taken as 20 mm. These results show that the presence of the PEG 1500 polymer in compositions 1B to 1E allows a dramatic reduction in the compaction force which is applied. Higher values of DFS could readily have been achieved without requiring compaction force to exceed 40 kN.

### EXAMPLE 2

Two detergent base powders, incorporating organic surfactants and detergency builder were made using the process described in WO-A-98/11193, with incorporation of the PEG 1500 by spraying it on as a liquid at around 70° C. before the moderate speed mixer. The powders had the following compositions. Amounts are shown both as weight percentages of the base powder.

wt. %

| Ingredient | A | B |
|---|---|---|
| Sodium linear alkylbenzene sulphonate | 23.60 | 20.73 |
| PEG 1500 | — | 4.49 |
| Nonionic surfactant (C13-15 branched | 7.05 | 6.19 |
| fatty alcohol 7EO) | | |
| Soap | 1.65 | 1.45 |
| Zeolite A24 (Zeolite MAP available | 40.61 | 42.51 |
| from Crosfields) | | |
| Sodium acetate trihydrate | 10.21 | 8.98 |
| Sodium carbonate | 4.97 | 4.33 |
| Linear sodium carboxymethyl cellulose | 0.92 | 0.81 |
| (SCMC) | | |
| Sodium citrate | 3.06 | 2.69 |
| Sodium sulphate, moisture and minor | 7.93 | 7.82 |
| ingredients | | |
| Total | 100 | 100 |

The amount of zeolite MAP (zeolite A24) in the table above is the amount which would be present if it was anhydrous. Its accompanying small content of moisture is included as part of the moisture and minor ingredients. Linear sodium carboxymethyl cellulose is a commonly used water soluble antiredeposition polymer.

A number of further ingredients were added to this base powder by dry-mixing (except the perfume, which was sprayed on) resulting in the following compositions:

Parts by Weight

| | Option 1 | Option 2 |
|---|---|---|
| Base powder A | 41.06 | — |
| Base powder B (includes PEG) | — | 43.22 |
| Anti-foaming granule | 1.74 | 1.74 |
| Fluorescer on sodium carbonate | 1.20 | 1.20 |
| Soil release polymer (18% on carrier) | 1.06 | 1.06 |
| Acrylate-maleate copolymer | 1.16 | 1.16 |
| Na-silicate (granular) 80% | 3.09 | 3.09 |
| TAED granules (83% active) | 4.91 | 4.91 |
| Sodium Percarbonate (coated) | 14.56 | 14.56 |
| Sequestrant granules (Dequest 2047) | 0.72 | 0.72 |
| Sodium acetate trihydrate | 22.79 | 22.79 |
| Blue speckles | 1.35 | 1.35 |
| PEG 1500 | 2.17 | — |
| Nylin LX-16 | 2.91 | 2.91 |
| Enzymes | 0.86 | 0.86 |
| Perfume | 0.44 | 0.44 |
| TOTAL | 100.00 | 100.00 |

The amount of PEG 1500 added to option 1 is slightly more than the amount of PEG included in option 2.

These compositions were compacted with several levels of applied force on a Fette rotary press to produce cylindrical tablets with a weight of approximately 42.5 grams, with target diametrical fracture stresses of 25 and 35 kPa.

The strength of the tablets, in their dry state as made on the press, was determined as in Example 1.

The disintegration of the tablets were tested (as in Example 1) by placing a tablet on a 1 cm by 1 cm gauze in 1 liter of still water at 10° C. and measuring the time (t₉₀) it takes for 90% by weight of the tablet to fall through the grid. The results are shown below.

| Option | DFS[kpa] | t₉₀[s] |
|---|---|---|
| 1 | 27 | 191 |
| | 36 | 256 |
| 2 | 25 | 150 |
| | 37 | 188 |

Option 2, using base powder B had equal strength but gave more rapid dissolution of its soluble constituents.

### EXAMPLE 3

Two detergent base powders, incorporating organic surfactants and detergency builder were made as in Examples 1 and 2. They had the following composition, which is shown as weight percentages of the base powder.

wt.%

| Ingredient | C | D |
|---|---|---|
| Sodium linear alkylbenzene sulphonated | 20.82 | 19.85 |
| PEG 1500 | — | 2.81 |
| Nonionic surfactant (C13-15 branched | 9.03 | 8.62 |
| fatty alcohol 7EO) | | |
| Soap | 1.59 | 1.51 |
| Zeolite A24 (Zeolite MAP from | 46.52 | 46.01 |
| Crosfields) | | |
| Sodium acetate trihydrate | 5.89 | 5.62 |
| Sodium carbonate | 6.92 | 6.29 |
| Linear sodium carboxymethyl cellulose | 0.88 | 0.84 |
| (SCMC) | | |
| Sodium sulphate, moisture and minor | 8.33 | 8.15 |
| ingredients | | |
| Total | 100.00 | 100.00 |

A number of further ingredients were added to this base powder by dry-mixing (except the perfume, which was sprayed on) resulting in the following composition:

| | Parts by Weight | | | |
|---|---|---|---|---|
| | Option | Option | Option | Option |
| | 1a | 1b | 2a | 2b |
| Base powder C | 43.00 | 47.78 | — | — |
| Base powder D (includes PEG) | — | — | 44.27 | 49.20 |
| Anti-foaming granule | 1.70 | 1.89 | 1.70 | 1.89 |
| Fluorescer on sodium carbonate | 1.30 | 1.44 | 1.30 | 1.44 |
| PVP granule | 0.15 | 0.17 | 0.15 | 0.17 |
| Soil release polymer (18% on | 0.50 | 0.56 | 0.50 | 0.56 |
| carrier) | | | | |
| Na-silicate (granular) 80% | 2.25 | 2.50 | 2.25 | 2.50 |
| TAED granules (83% active) | 3.50 | 3.89 | 3.50 | 3.89 |
| Sodium Percarbonate (coated) | 14.00 | 15.56 | 14.00 | 15.57 |
| Sequestrant granules (Dequest | 0.75 | 0.83 | 0.75 | 0.84 |
| 2047) | | | | |
| Sequestrant granule (Dequest | 0.50 | 0.55 | 0.50 | 0.55 |
| 2016) | | | | |
| Sodium citrate | 3.00 | 3.33 | 3.00 | 3.33 |
| Sodium acetate trihydrate | 21.00 | 12.22 | 21.73 | 13.00 |
| PEG 1500 | 2.00 | 2.22 | — | — |
| Nylin LX-l6 | 5.00 | 5.56 | 5.00 | 5.56 |
| Enzymes | 0.90 | 1.00 | 0.90 | 1.00 |
| Perfume | 0.45 | 0.50 | 0.45 | 0.50 |
| TOTAL | 100.0 | 100.0 | 100.0 | 100.0 |

The compositions were compacted on a Fette rotary press to produce cylindrical tablets with a weight of approximately 42.5 grams (for tablets of 1a and 2a) and 38.5 grams (for tablets of 1b and 2b). The applied force was adjusted to give strength close to a target diametrical fracture stress of 25 kPa. The tablets were chosen to provide approximately equal amounts of the surfactant, builder and bleach.

All of these tablets contained hydrated sodium acetate and citrate among the materials added to the granulated particles. Incorporation of this material is known to increase the speed of tablet dissolution, compared to tablets of similar strength without sodium acetate trihydrate, as taught in EP 838519 A (Unilever). The amounts used in options 1b and 2b were less than the amounts used in options 1a and 2a.

The diametrical fracture stress of the tablets was measured as in Example 1. The disintegration of the tablets was measured by placing two tablets of each type in a washing machine dispenser. The dispenser was of a type used in Philips washing machines (AWB 126/127). Water at 10° C. flowing at a rate of 5 liters per minute was passed through the dispenser until the two tablets were completely washed out of the dispenser. The time was noted as the dispensing time and is reported in the table below which also summarises the distinctions between the four tablet formulations.

| | | option 1b | | option 2b |
|---|---|---|---|---|
| | | PEG added | option 2a | PEG in base |
| | option 1a | separately. | PEG in | powder. |
| | PEG added | Reduced | base | Reduced |
| | separately. | acetate | powder. | acetate |
| Weight (g) | 42.6 | 38.5 | 42.6 | 38.5 |
| Compaction | 8.3 | 7.1 | 14.6 | 12.4 |
| Force (kN) | | | | |
| DFS (kPa) | 24.9 | 25.4 | 25.5 | 27.7 |
| Dispensing | 70 | 102 | 68 | 66 |
| time (sec) | | | | |

Option 1a and option 2a used similar, fairly high, concentrations of sodium acetate. Both provided similar strength with similar time for the tablets to disintegrate and wash from the dispenser into the washing machine. This was not predictable because the PEG was incorporated within the granular particles in option 2a rather than added separately as in option 1a.

Option 1b and option 2b had a reduced concentration of sodium acetate. Option 1b gave a longer disintegration time than option 1a. Unexpectedly, however, option 2b disintegrated as rapidly as options 1a and 2a.

### EXAMPLE 4

A detergent base powder was made by a neutralisation and granulation process as described in WO-A-98/11193. A quantity of it was modified by coating the particles with polyethylene glycol (PEG 1500) in a fluidised bed. The powder was heated to 50° C. in the fluidised bed and the PEG 1500 was sprayed on at 80° C.

The formulations of the base powders were:

WT %

| Ingredients | 4A | 4B |
|---|---|---|
| Sodium linear alkylbenzene sulphonated | 22.71 | 21.83 |
| Nonionic surfactant (C13-C15 branched | 3.49 | 3.36 |
| fatty alcohol 3EO) | | |
| Nonionic surfactant (C13-C15 branched | 6.44 | 6.19 |
| fatty alcohol 7EO) | | |
| Soap | 1.75 | 1.68 |
| Zeolite A24 (Zeolite MAP available | 46.40 | 44.61 |
| from Crosfields) | | |
| Sodium acetate trihydrate | 6.44 | 6.19 |
| Sodium carbonate | 7.53 | 7.25 |
| Linear sodium carboxymethyl cellulose | 0.98 | 0.95 |
| (SCMC) | | |
| Sodium sulphate, moisture and minor | 4.26 | 4.09 |
| ingredients | | |
| PEG 1500 | — | 3.85 |
| Total | 100.00 | 100.00 |

A number of further ingredients were added to these base powders by dry-mixing (except the perfume, which was sprayed on) resulting in the following compositions:

| | A | | B | |
|---|---|---|---|---|
| | Parts | | Parts | |
| | by | | by | |
| | weight | wt % | Weight | wt % |
| Base powder 4A | 19.46 | 55.25 | — | — |
| Base powder 4B | — | — | 20.59 | 58.20 |
| (includes PEG) | | | | |
| Anti-foaming granule | 0.61 | 1.73 | 0.61 | 1.72 |
| Fluorescer on sodium | 0.42 | 1.19 | 0.42 | 1.19 |
| carbonate | | | | |
| Acrylate/maleate copolymer | 0.40 | 1.14 | 0.40 | 1.13 |
| (Sokolan CP5) | | | | |
| Soil release polymer (18% | 0.37 | 1.05 | 0.37 | 1.05 |
| on carrier) | | | | |
| Na-silicate (granular) 80% | 1.08 | 3.07 | 1.08 | 3.05 |
| TAED granules (83% active) | 1.72 | 4.88 | 1.72 | 4.86 |
| Sodium Percarbonate (coated) | 5.10 | 14.48 | 5.10 | 14.41 |
| Sequestrant granules | 0.25 | 0.71 | 0.25 | 0.71 |
| (Dequest 2047) | | | | |
| Sodium acetate trihydrate | 3.23 | 9.17 | 3.23 | 9.13 |
| PEG 1500 | 0.97 | 2.75 | — | — |
| Nylin LX-16 | 1.61 | 4.5713 | 1.61 | 4.5506 |
| TOTAL | 35.22 | 100 | 35.38 | 100 |

The compositions were compacted on a benchtop Specac air press to produce cylindrical tablets with a weight of 35.22 grams (for tablets A) and 35.38 grams (for tablets B). Various compaction forces were used. Strength of the tablets was measured as in Examples 1 to 3. Dispensing residue was measured using a Philips dispenser as in Example 3. 5 liters of water at 10° C. was passed through the dispenser during a period of 1 minute. The residue of tablets remaining in the dispenser was then collected, dried for 12 hours at 90° C., and weighed.

The results determined were:

| | Compaction | | |
|---|---|---|---|
| | Force kN | DFS | Residue (%) |
| A | 9.0 | 32 | 40 |
| B | 4.5 | 41 | 14 |

It can be seen that PEG sprayed onto the base powder gave a considerable improvement in properties compared to PEG added as powder.

### EXAMPLE 5

Disintegrant particles were prepared from:

(i) microcrystalline cellulose with a particle size of 50 microns (Lattice NT type 50D); when this material comes into contact with water, it expands to about 1.5 times its dry volume.

(ii) Cross-linked carboxymethyl cellulose (Nylin XL-50D); this cross-linked carboxymethyl cellulose expands considerably when brought into contact with water, swelling to approximately 3 times its original volume.

(iii) Polyethylene glycol of average molecular weight 1500 (PEG 1500) was used in the form of powder.

The materials were mixed in a laboratory scale V-blender and then compacted into flakes. For the purpose of this example, compaction was carried out using a laboratory scale compactor and then crushed to a size of approximately 1500 microns using a “Siebmühle FC 200” from Hosokawa Bepex. This machine has a rotor which cuts the material through a mesh which in this case has a mesh size of 1.5 mm (1500 microns). The resulting particles have a size and size distribution which is dependent on the size of the screen through which they are forced, but also on the brittleness and hardness of the material and the speed of the rotor. The screen determines an upper limit on the particle size. Some fine particles are generated during the compaction process. In this example the resulting particles were used without further sieving or size selection.

Disintegrant particles were prepared containing about 90% microcrystalline cellulose (Lattice NT type 50D) mixed with about 5% of each of cross-linked CMC (Nylin XL-50D) and PEG 1500.

After compaction, crushing and sieving they had mean particle size in a range from 1000 to 1500 microns.

A detergent base powder was prepared by granulation so as to have a composition as set out in the following table:

| Ingredient | Parts by Weight |
|---|---|
| Sodium linear alkylbenzene sulphonate | 9 |
| C₁₃₋₁₅ fatty alcohol 7EO. | 2.6 |
| C₁₃₋₁₅ fatty alcohol 3EO. | 1.4 |
| Soap | 0.7 |
| Zeolite A24 (Zeolite MAP from Crosfields. | 20 |
| Sodium acetate trihydrate | 2.6 |
| Linear sodium carboxymethylcellulose | 0.4 |
| Impurities or moisture | Balance to 44 |

A number of further ingredients were added to this base powder by dry-mixing resulting in the following composition:

| | Parts by |
|---|---|
| | Weight |
| Base powder | 45.20 |
| Anti-foaming granule | 1.80 |
| Fluorescer on sodium carbonate | 1.26 |
| Soil release polymer (18% on carrier) | 1.10 |
| Na-silicate (granular) 80% | 3.22 |
| TAED granules (83% active) | 5.12 |
| Sodium Percarbonate (coated) | 15.19 |
| Sequestrant granules (Dequest 2047) | 0.74 |
| Acrylate maleate copolymer | 1.21 |
| Sodium acetate trihydrate | 23.77 |
| Disintegrant particles | 3.00 |
| TOTAL | 100.0 |

The compositions were compacted on a Fette rotary press to produce cylindrical tablets with a weight of approx. 41 grams. These were tested as in Example 4: DFS was over 30 kPa, and there was no dispensing residue.

1. A tablet of compacted particulate detergent composition comprising non-soap surfactant and detergency builder, wherein the tablet or a discrete region thereof comprises;
a) disintegration-promoting particles which comprise from about 0.1 to about 10% by weight of the particles of water-swellable, water-insoluble disintegrant material which is able to swell to at least twice its volume on contact with water, mixed with from about 75 to about 99.9% by weight of the particles of a water-absorbent carrier material which does not swell to as much as twice its volume on contact with water, and
b) water-soluble polymeric binder which is solid at about 25° C., and
c) from about 2 to about 30% by weight of water-soluble disintegration-promoting particles comprising at least about 40% (by weight of the particles) of one or more materials selected from the group consisting of;
compounds with water solubility in deionised water at 20° C. of at least about 50 grams per 100 grams of water
phase I sodium tripolyphosphate
sodium tripolyphosphate which is partially hydrated so as to comprise of hydration in an amount which is at least about 0.5% by weight of the sodium tripolyphosphate in the particles.

2. The tablet according to claim 1 wherein the disintegration-promoting particles comprise about 1 to about 15% by weight of the particles of water-soluble organic polymer.

3. The tablet according to claim 1 having a diametral fracture stress of at least about 14 kPa.

4. A tablet of compacted particulate detergent composition comprising spray dried or agglomerated base particles comprising non-soap surfactant and detergency builder, wherein the tablet has a diametral fracture stress of at least about 14 kPa, and wherein the tablet or a discrete region thereof comprises disintegration-promoting particles which swell on contact with water and which comprise water-swellable, water-insoluble material, admixed with the base particles, and wherein the tablet further comprises water-soluble polymeric binder which is solid at about 25° C.

5. The tablet according to either claim 3 or claim 4 having a diametral fracture stress of at least about 20 kPa.

6. The tablet according to claim 4 which further comprises water-soluble disintegration-promoting particles comprising at least about 40% (by weight of the particles) of one or more materials selected from the group consisting of;
compounds with water solubility in deionised water at 20° C. of at least about 50 grams per 100 grams of water
phase I sodium tripolyphosphate
sodium tripolyphosphate which is partially hydrated so as to comprise water of hydration in an amount which is at least about 0.5% by weight of the sodium tripolyphosphate in the particles.

7. The tablet according to either claim 1 or claim 6 wherein the water-soluble disintegration-promoting particles comprise at least about 40% (by weight of the particles) of one or more salts with compounds with a water solubility in deionised water at 20° C. of at least about 50 grams per 100 grams of water, and mixtures thereof.

8. The tablet according to either claim 1 or claim 6 wherein the water-soluble disintegration-promoting particles in the tablet or region thereof comprise at least about 40% (by weight of the particles) of phase I sodium tripolyphosphate which is partially hydrated so as to comprise water of hydration in a range from about 0.5 to about 4% by weight of these particles.

9. The tablet according to claim 6, comprising from about 2 to about 30% by weight of the water-soluble disintegration promoting material.

10. The tablet according to either claim 1 or claim 4 wherein the tablet comprises about 0.1 to about 15% by weight of organic polymer.

11. The tablet according to either claim 1 or claim 4 wherein the overall quantity of water-swellable disintegrant particles in the tablet is between about 0.1 and about 20% by weight of the tablet.

12. The tablet according to either claim 1 or claim 4 wherein the water-swellable disintegrant particles have a mean particle size in a range from about 250 to about 1500 micrometers.

13. The tablet according to either claim 1 or claim 4 wherein the tablet comprises from about 5 to about 50% by weight of surfactant and from about 5 to about 80% by weight of water-softening agent.

14. The tablet according to either claim 1 or claim 4 wherein the tablet comprises water-insoluble detergency builder in an amount from about 5 to about 98% by weight of the tablet or region thereof.

15. The tablet according to either claim 1 or claim 4 comprising from about 10 to about 80% by weight of water-soluble detergency builder.

16. The tablet according to either claim 1 or claim 4 wherein the tablet comprises from about 1 to about 5% by weight of surfactant, from about 0.1 to about 20% by weight of the water-swellable disintegration-promoting particles and from about 50 to about 98% by weight of detergency builder.

17. Process for making a tablet of compacted particulate detergent composition, the process comprising the steps;
a) producing a particulate detergent composition by mixing;
i) disintegrant particles comprising from about 0.1 to about 10% by weight of the particles of water-swellable, water-insoluble disintegrant material which is able to swell to at least twice its volume on contact with water, mixed with from about 75 to about 99.9% by weight of the particles of a water-absorbent carrier material which does not swell to as much as twice its volume on contact with water, with
ii) other constituents of the particulate detergent composition comprising organic surfactant and detergency builder, and
iii) water-soluble polymeric binder which is solid at about 25° C., and
iv) from about 2 to about 30% by weight of water-soluble disintegration-promoting particles comprising at least about 40% (by weight of the particles) of one or more materials selected from the group consisting of;
compounds with water solubility in deionised water at 20° C. of at least about 50 grams per 100 grams of water
phase I sodium tripolyphosphate
sodium tripolyphosphate which is partially hydrated so as to comprise water of hydration in an amount which is at least about 0.5% by weight of the sodium tripolyphosphate in the particles, and
b) placing a quantity of the resulting particulate detergent composition from step a) within a mould and compacting the composition within the mould to produce the tablet.

18. Process for making the tablet according to claim 4 the process comprising the steps;
a) producing a particulate detergent composition by mixing;
i) disintegrant particles which swell on contact with water and which comprise water-swellable, water-insoluble material, with
ii) other constituents of the particulate detergent composition including organic surfactant and detergency builder, and wherein water-soluble polymer is present in the detergent composition, and
b) placing a quantity of the resulting particulate detergent composition within a mould and compacting that composition within the mould to produce the tablet.

19. The process according to either claim 17 or 18 wherein the mould has a rigid structure surrounding a cavity and a pair of punches movable towards each other within the cavity to compact within the cavity the composition by application of a compaction pressure.

20. The process according to either claim 17 or 18 wherein the compaction pressure used in step b) does not exceed about 35 MPa.
